(19) United States
(12) Patent Application Publication
(10) Pub. No.: US 2003/0041006 A1
(43) Pub. Date: Feb. 27, 2003

(54) Methods and systems for suppression of stale or invalid data in a securities quotation display

(76) Inventor: John Bunda, Austin, TX (US)

Correspondence Address: ERIC B. MEYERTONS, CONLEY, ROSE & TAYON, P.C., P.O. BOX 398, AUSTIN, TX, 78767-0398, US

(21) Appl. No.: 09/934,448

(22) Filed: Aug. 21, 2001

(51) Int. Cl. G06F 17/60; H04K 1/00; H04L 9/00

(52) U.S. Cl. 705/37

(57) ABSTRACT

Methods and systems for displaying information related to securities to a user are provided. In an embodiment, a method may include storing securities quotes in a memory of a computer. The method may include receiving quote updates information. The received quote update information and the quotes stored in the memory of the computer may be compared via one or more criteria. For bid quotes, a first criterion may include determining if a quote stored in the memory of the computer is greater than the price of a quote update. For ask quotes, the first criterion may include determining if a quote stored in the memory of the computer is less than the price of a quote update. A second criterion may include determining if a timestamp associated with the quote update minus a timestamp associated with the quote stored in the memory of the computer is greater than a predetermined threshold time. If one or more of the criteria are met, the method may modify the quote in the memory of the computer. Modifying the quote may include, but is not limited to: changing a display color, changing a font style, inhibiting the quote from being displayed, and deleting the quote from the memory of the computer.

### BACKGROUND OF THE INVENTION

1. Field of the Invention

The present invention generally relates to computer software. Certain embodiments relate to computer-implemented methods for monitoring securities quotes (e.g., quotes for stocks, options contracts, futures, bonds, mutual funds, and other investments).

2. Description of the Related Art

The securities trading industry has burgeoned since the advent of the Internet. Many companies offer securities trading services through a variety of automated systems, such as a telephone system or a computer system. For example, placing orders to buy or sell securities may include using an order entry screen on a computer system. Before placing an order, a trader of securities may review technical analysis data and/or securities quotes which may aid in making trading decisions.

A securities exchange, or securities market (e.g., a stock market) may facilitate trading in securities by communicating open quotes and orders. A securities exchange may also use market centers to match buyers and sellers of a security. For example, the NASDAQ Stock Market uses the Small Order Exchange System (“SOES”), SelectNet and Electronic Communication Networks (“ECNs”). SOES, SelectNet and ECNs may be referred to generally as market centers.

Market makers participating in a market commit capital to buy and sell securities on the market. Under the rules of certain markets (e.g., the NASDAQ Stock Market), a market maker participating in the exchange of a particular security is expected to provide both buy and sell quotes for that security. These quotes do not necessarily represent actual orders; rather they represent a willingness on the part of the market maker to execute transactions at the quoted price. SOES/SelectNet are non-negotiated exchanges in which market makers may place offers and bids, and may be required to meet fill requirements set forth in a participation agreement with the National Association of Securities Dealers (“NASD”). Since SOES/SelectNet are non-negotiated, it may be desirable for certain traders in securities to bypass SOES/SelectNet in favor of negotiating a transaction with an ECN which may be better than the current best bid or ask price on SOES/SelectNet.

Typically, in order to list a price through an ECN, a trader places a limit order. If a limit order placed through an ECN meets certain criteria, the order may be advertised in the ECN's order book. An order book may be communicated to a securities exchange electronically. By using an ECN, traders may bypass the SOES/SelectNet network and thus may make markets by playing or splitting the spread. Individual traders are not permitted to post quotes directly through SOES/SelectNet. Examples of ECNs may include Arcapelago (“ARCA”), Bloomberg (“BTRD”), Instinet (“INCA”), Island (“ISLD”), Spear Leeds (“REDI”), and SelectNet (“NASD”).

To facilitate trading, a market generally provides traders with open quote and order information. Generally, open quote and order information may be provided in two ways. First, an overall market summary for a security may be presented. A second way that quote and order information may be provided is through a market quote/order book. For example, with regard to the NASDAQ Stock Market, the market summary may be referred to as Level 1 market data, and the market quote/order book may be referred to as Level 2 market data.

A securities market may provide access to the market quote/order book or market summary for listed securities. A trader may be provided with access directly to the market quote/order book or market summary. Alternately, the trader may be provided with access to the market quote/order book or market summary by a securities trading company. The securities trading company may manipulate the market quote/order book or market summary information in various ways, including but not limited to: formatting the information, merging information from several sources, and analyzing the information. The market quote/order book or market summary information may be provided to the traders in real-time, or time delayed.

Automated securities trading systems have been developed to provide traders with access to securities market information, including market quote/order books and market summaries. Automated securities trading systems may maintain a database or list of securities trading information. The automated securities trading system may be linked to an automated securities market update system via a network (e.g., the Internet). The automated securities market update system may send updates of the securities market's market information to an automated securities trading system. The automated securities trading system may be configured to receive updates from the securities market update system, and make changes or additions to the database of securities trading information based on the updates.

An automated securities trading system may be configured to display at least some of the securities trading information in the database to a user. The securities trading information may be displayed on a first computer system, where the automated securities trading system resides. The securities trading information may also be displayed on a second computer system, where the first and second computer system are connected to a network (e.g., the Internet or a Local Area Network). In certain cases, market information in an automated securities trading system may include erroneous data. For example, an automated securities trading system may receive market information updates from an automated securities market update system via a computer network. In such cases, update information sent by the automated securities market update system may not be received by the automated securities trading system. The updates may not be received due to various network communications problems, including but not limited to: the loss of one or more electronic data packets, or the loss of a network connection. As a result, erroneous data may be displayed to a trader, and/or retained within an automated securities trading system.

### SUMMARY OF THE INVENTION

Embodiments presented herein relate to improved computer-implemented methods and systems for displaying information related to securities to a user. In certain embodiments, systems and methods may detect erroneous or potentially erroneous quote information. In an embodiment, a system and a method may inhibit the display of quotes determined to be erroneous or potentially erroneous. In an embodiment, a system and a method may include a database or list of quotes. In such an embodiment, the system and method may include deleting from the database of quotes one or more quotes determined to be erroneous or potentially erroneous.

Embodiments described herein may interact with other securities trading systems and methods. For example, embodiments described herein may interact with systems and methods described in co-pending U.S. patent application Ser. No. 09/460,045, which is incorporated by reference as if full set forth herein.

In an embodiment, a method of displaying securities quote information, may include receiving quote updates from an automated securities market update system. The quote updates received may be market summary updates. The method may further include comparing a quote update for a particular security received to one or more quotes for the security stored in the memory of a computer. The comparison may determine if one or more predetermined criteria are met. Any quote for the security which meets one or more of the predetermined criteria may be modified. Alternately, any quote which meets all of the predetermined criteria may be modified. Modifications to the quote may include modifying one or more quote display formatting settings for the quote. The quote display formatting settings may include, but are not limited to: display color, and display font. Modifications may also include inhibiting the quote from being displayed. Further, modifications may include deleting the quote from a list or database of quotes.

In certain embodiments, the method may include comparing a quote stored in the memory of the computer to a received quote update. For a bid quote, a first comparison criterion may include determining if the price of the quote stored in the memory of the computer is greater than the price of a quote update. If the price of the quote stored in the memory of the computer is greater than the price of a quote update, then the first bid quote criterion may be met. For an ask quote, a first comparison criterion may include determining if the price of the quote stored in the memory of the computer is less than the price of a quote update. If the price of the quote stored in the memory of the computer is less than the price of a quote update, then the first ask quote criterion may be met.

In certain embodiments, a method may include providing a timestamp for each quote update received. The timestamp may be provided at the point of origination (i.e., the securities market update system) or the point of receipt (i.e., the securities trading system). In such embodiments, a second criterion for comparing a quote update and a quote stored in the memory of a computer may include determining if a timestamp associated with the quote stored in the memory of the computer is older than a timestamp associated with a quote update by more than a predetermined threshold time. If the quote in the memory of the computer is older than the quote update by more than a predetermined time threshold the second criterion may be met. In some embodiments, the predetermined time threshold may be equal to zero (i.e., no time threshold). In some embodiments, the predetermined time threshold may be user configurable.

In some embodiments, only the first criterion may be used. In some embodiments, only the second criterion may be used. In some embodiments, both the first criterion and the second criterion may be used.

An additional embodiment may relate to a system configured to display securities information. The system may include a first computer system coupled to a network. The first computer system may also include a display system configured to display securities information in a quote display format. In addition, the first computer system may be configured to receive securities information from the network, to store at least a portion of the received securities information in a database, and to display securities information in the quote display format. In particular, the first computer system may be configured to receive quote updates. Alternatively, a second computer system may be configured to receive securities information from the network and to display securities information in the quote display format.

A further embodiment may relate to a carrier medium which may store program instructions. For example, the carrier medium may include a memory medium. The program instructions may be computer-executable to implement methods described above.

### BRIEF DESCRIPTION OF THE DRAWINGS

FIG. 1 depicts an illustration of an embodiment of a computer system suitable for implementing various embodiments;

FIG. 2 depicts a schematic diagram of an embodiment of a wide area network suitable for implementing various embodiments;

FIG. 3 depicts a flow chart illustrating a method for summarizing market quote and order information into a market quote/order book and a market summary; and

FIG. 4 depicts a flowchart illustrating a first method for detecting and modifying erroneous or potentially erroneous quote information.

FIG. 5 depicts a flowchart illustrating a second method for detecting and modifying erroneous or potentially erroneous quote information.

FIG. 6 depicts a flowchart illustrating a third method for detecting and modifying erroneous or potentially erroneous quote information.

While the invention is susceptible to various modifications and alternative forms, specific embodiments thereof are shown by way of example in the drawings and will be described in detail herein. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF SEVERAL EMBODIMENTS

Embodiments disclosed herein generally relate to methods and systems for displaying information related to securities to a user. As used herein, a “security” may generally refer to an investment instrument issued by a corporation, government, or other organization which may offer evidence of debt or equity (e.g., stocks, options contracts, futures, bonds, mutual funds, and other investments). As used herein, “technical analysis” may generally refer to a method for evaluating securities by relying on an assumption that market data (e.g., charts of price, volume, and open interest) may aid in predicting future (usually relatively short-term) market trends. As used herein, a “quote” refers to an advertised willingness to buy or sell a specified number of shares of a security at a specified price. A solicitation to buy a security specifies a bid price. As used herein, a “bid price” may generally refer to the price that a buyer may be willing to pay for a security at a specified time. Conversely, a solicitation to sell specifies an ask price. As used herein, an “ask price” may generally refer to the price that a seller may be willing to accept for a security at a specified time. As used herein, a “trade price” or “price” of a security may generally refer to a price of a transaction for the security.

As used herein, an “order” is a request to buy or sell a specified number of shares of a security. An order which specifies a price is called a “limit order.” An order which does not specify a price is called a “market order.” A market order may be executed at the best price currently available on the market. As used herein, the “spread” may generally refer to the difference between the best (i.e., highest) current bid price and the best (i.e., lowest) current ask price for a security. For example, the best current bid price for a security may be 92.25, and the best current ask price for the security may be 92.75. Therefore, the spread between the bid price and the ask price may be 0.5 points (i.e., the difference between 92.75 and 92.25 is 0.5: a “Point” is $1, thus a 0.5 points is $0.50). An order may also specify a trading direction. As used herein, a “trading direction” or “side” may generally refer to whether the quote is an advertised willingness to buy the security or an advertised willingness to sell the security. When the trading direction is an advertised willingness to buy, the price may be referred to as a “bid price,” and the quote is referred to as a “bid quote.” Conversely, when the trading direction is an advertised willingness to sell, the price may be referred to as an “ask price,” and the quote is referred to as an “ask quote.”

As used herein, an “ECN” may generally refer to a market center which includes an order matching system that may allow traders to advertise a price for a security. As used herein, an “order book” may generally refer to a listing of open orders available through a market center. As used herein, a “market maker” may generally refer an entity (e.g., a brokerage, a bank) that maintains an orderly market in a security by standing ready, willing, and able to buy and sell the security. As used herein, a “market quote/order book” may generally refer to a set of quotes including the best available bid and ask price from each market center participating in trading the particular security. As used herein, a “market center” may refer to a network or system which facilitates trading in securities. For example, an ECN may be considered a market center. The SOES network may be considered a market center.

As used herein, “real-time” may generally refer to a response to stimuli within some relatively small upper limit of response time (e.g., seconds or minutes).

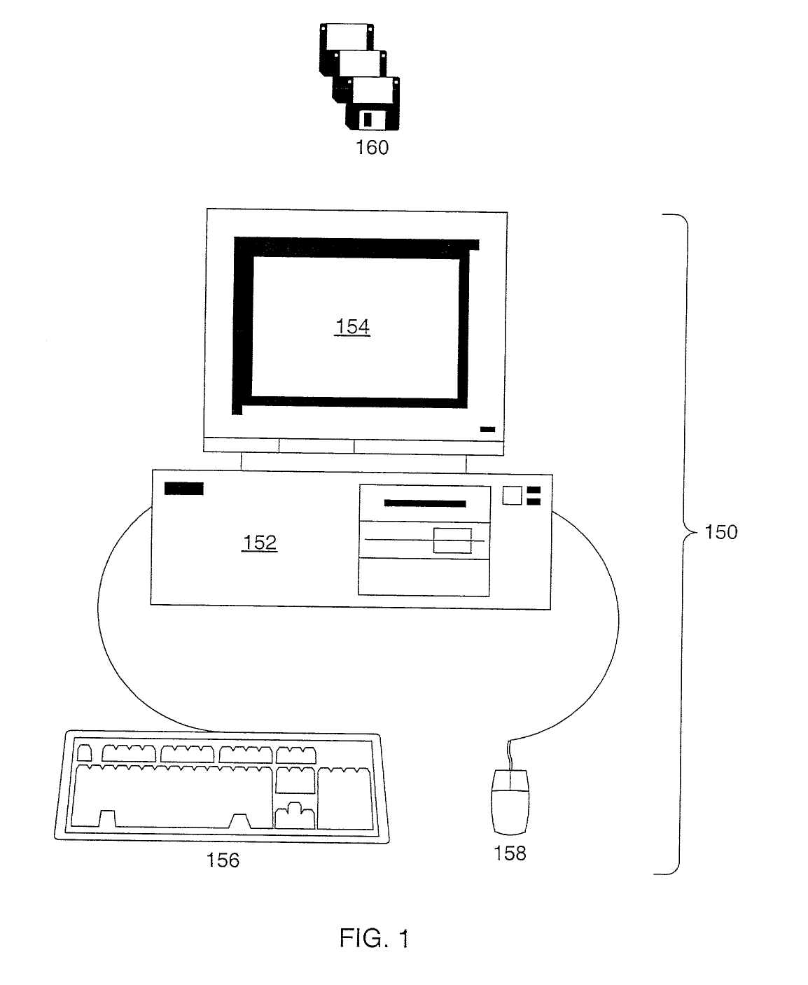

FIG. 1 illustrates an embodiment of computer system 150 which may be suitable for implementing various embodiments of a system and a method for displaying information related to securities to a user. Computer system 150 may typically include components such as CPU 152 with an associated memory medium such as floppy disks 160. The memory medium may be configured to store program instructions for computer programs. The program instructions may be executable by CPU 152. Computer system 150 may further include a display device such as monitor 154, an alphanumeric input device such as keyboard 156, and a directional input device such as mouse 158. Computer system 150 may be operable to execute the computer programs to implement a method for displaying information related to securities as described herein.

Computer system 150 may preferably include a memory medium on which computer programs according to various embodiments may be stored. The term “memory medium” may generally refer to an installation medium, e.g., a CD-ROM, or floppy disks 160, a computer system memory such as DRAM, SRAM, EDO RAM, Rambus RAM, etc., or a non-volatile memory such as a magnetic media (e.g., a hard drive, or optical storage). The memory medium may include other types of memory as well, or combinations thereof. In addition, the memory medium may be located in a first computer in which the programs may be executed. Alternatively, the memory medium may be located in a second different computer which may connect to the first computer over a network. In the latter instance, the second computer may provide program instructions to the first computer for execution. In addition, computer system 150 may take various forms such as a personal computer system, mainframe computer system, workstation, network appliance, Internet appliance, personal digital assistant (PDA), television system or other device. In general, the term “computer system” may be broadly defined to encompass any device having a processor which may execute instructions from a memory medium.

The memory medium may preferably store a software program or programs for displaying information related to securities as described herein. The software program(s) may be implemented in any of various ways such as procedure-based techniques, component-based techniques, and/or object-oriented techniques, among others. For example, the software program(s) may be implemented using ActiveX controls, C++ objects, JavaBeans, Microsoft Foundation Classes (MFC), browser-based applications (e.g., Java applets), traditional programs, or other technologies or methodologies, as desired. A CPU, such as host CPU 152, executing instructions from the memory medium may include a means for creating and executing the software program or programs according to the methods described below.

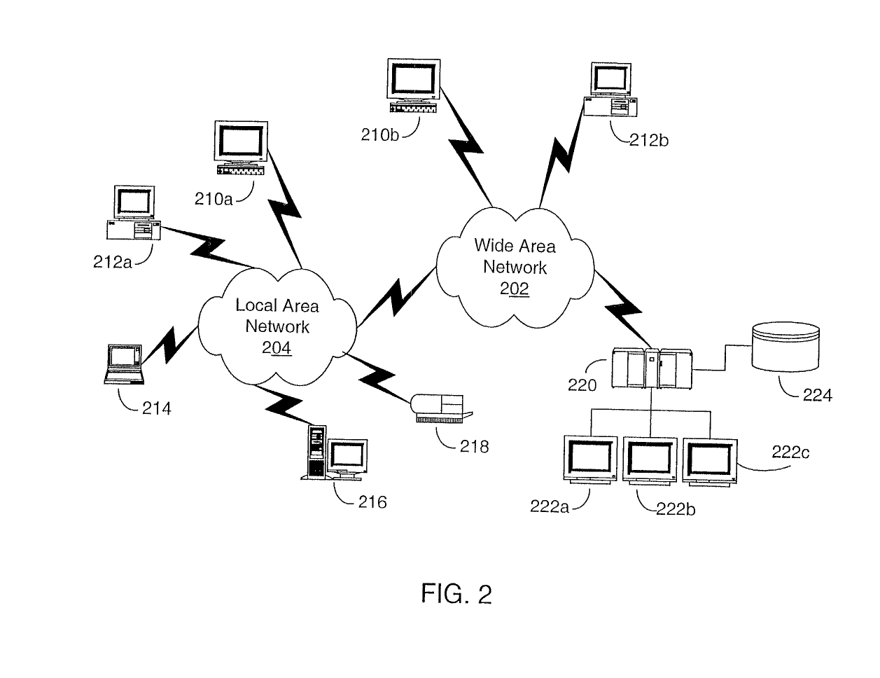

FIG. 2 illustrates a wide area network (WAN) according to one embodiment. WAN 202 may be a network that spans a relatively large geographical area. The Internet is an example of a WAN. WAN 202 may typically include a plurality of computer systems which may be interconnected through one or more networks. Although one embodiment is shown in FIG. 2, WAN 202 may include a variety of heterogeneous computer systems and networks which may be interconnected in a variety of ways and which may run a variety of software applications.

One or more local area networks (LANs) 204 may be coupled to WAN 202. A LAN may be a network that spans a relatively small area. For example, a LAN may be confined to a single building or a group of buildings. Each node (i.e., individual computer system or device) on LAN 204 may preferably have its own CPU with which it may execute programs. In addition, each node may be able to access data and devices anywhere on LAN 204. LAN 204 may thus allow many users to share devices (e.g., printers) as well as data stored on file servers. LAN 204 may be characterized by any of a variety of types of topology (i.e., a geometric arrangement of devices on the network), of protocols (i.e., rules and encoding specifications for sending data, and whether the network uses a peer-to-peer or client/server architecture), and of media (e.g., twisted-pair wire, coaxial cables, fiber optic cables, or radio waves).

Each LAN 204 may include a plurality of interconnected computer systems and optionally one or more other devices such as one or more workstations 210a, one or more personal computers 212a, one or more laptop or notebook computer systems 214, one or more server computer systems 216, and one or more network printers 218. As illustrated in FIG. 2, LAN 204 may include one of each of computer systems 210a, 212a, 214, and 216, and one printer 218. LAN 204 may be coupled to other computer systems and/or other devices and/or other LANs 204 through WAN 202.

One or more mainframe computer systems may be coupled to WAN 202. As shown, mainframe computer system 220 may be coupled to a storage device or file server 224 and mainframe terminals 222a, 222b, and 222c. Mainframe terminals 222a, 222b, and 222c may access data stored in the storage device or file server 224 coupled to or included in mainframe computer system 220.

WAN 202 may also include computer systems, which are connected to WAN 202 individually and not through a LAN 204 such as workstation 210b and personal computer 212b. For example, WAN 202 may include computer systems which may be geographically remote and connected to each other through the Internet.

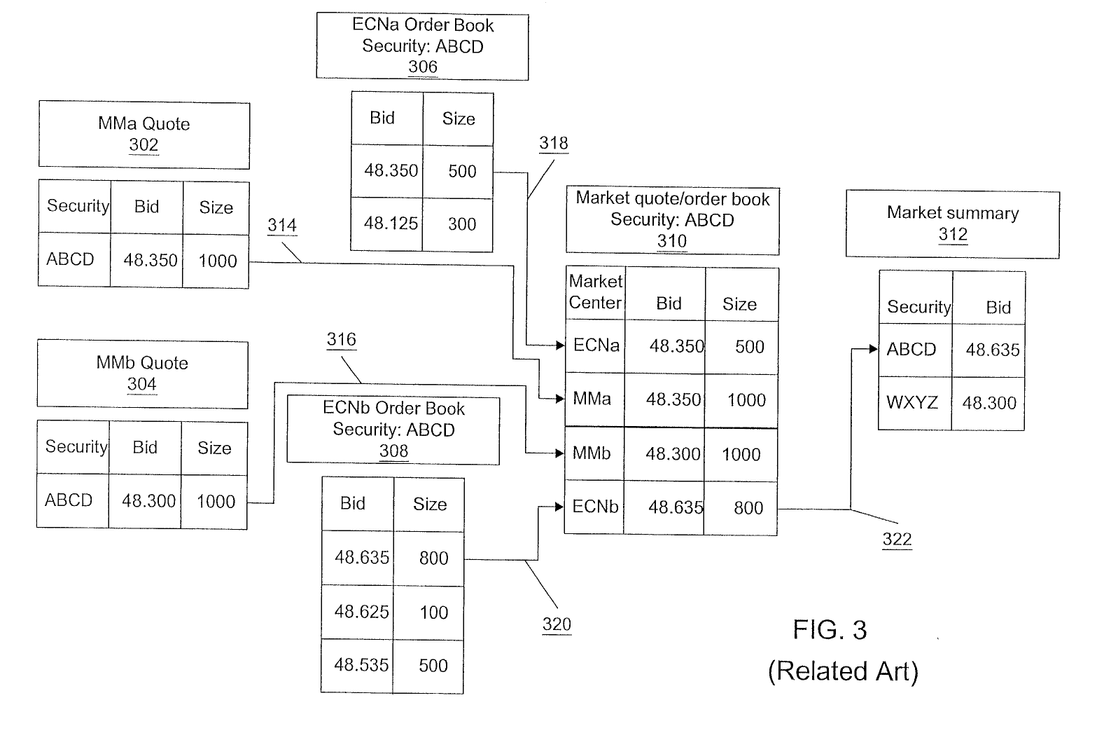

FIG. 3 depicts an example flowchart for generating a market quote/order book and a market summary from several market centers. A “market summary” for a security may include a best bid quote price and best ask quote price available on the market at the time of the summary regardless of the source of the bid or ask price. For example, the best bid price may be a limit order available to the market through an ECN, while the best ask price may be a quote from a market maker. A quote from market maker MMa is generally referenced by numeral 302. A quote from market maker MMb is generally referenced by numeral 304. Both quote 302 and 304 show only bid quotes. It is recognized that generally market makers provide both bid and ask quotes; however, ask quotes have been omitted to simplify the depiction of the flow chart. An ECN order book from ECNa is referenced by numeral 306. An ECN order book from ECNb is referenced by numeral 308. As shown, both of ECN order books 306 and 308 pertain only to the security identified by the symbol “ABCD.” ECN order books 306 and 308 depict only the bid orders for security ABCD. It is recognized that an ECN order book may generally contain both bid and ask orders for more than one security. A similar flow chart could be constructed for ask quotes and orders.

Market quote/order book 310 for security ABCD is composed of the best (e.g., highest) bid price from each ECN order book and each market maker quote. This data flow is depicted by arrows 314, 316, 318, and 320. A market summary may be generated by compiling information from market quote/order books for several securities. For example, market summary 312 depicts a market summary which includes securities ABCD and WXYZ. The bid price listed for security ABCD in market summary 312 is the best bid price (i.e., “48.635”) from market quote/order book 310 as depicted by data flow arrow 322. With regard to the NASDAQ Stock Market, the market summary may be referred to as Level 1 market data. With regard to the NASDAQ Stock Market, the market quote/order book may be referred to as Level 2 market data.

In some instances, after a quote has been placed it may be changed. For example, the quote may be changed because it is filled and is therefore no longer valid. If a quote is changed, a market may transmit a quote update. A “quote update,” may generally refer to a notice that a quote has been modified. A quote update may provide data regarding the quote as changed. The quote update may include, but is not limited to: a quote update price, a trading direction, a security identification, and a market center identification for the market center listing the quote. In some embodiments, quote updates may be used by a securities trading company to update one or more quotes stored in a memory of a computer associated with an automated securities trading system. The database of quotes may be used to provide a display of quotes to one or more users of the system. If the quote update affects the best bid or best ask quote on the market, the market may also send market summary update information. “Market summary update information” may refer to an indication that the best advertised quote for the security in the trading direction has changed. Market summary update information may include, but is not limited to: a new best quote price, a trading direction, a security identification, and a market center identification. In some embodiments, market quote/order book quote updates (e.g., Level 2 data) may be used to update the one or more quotes stored in the memory of a computer, while market summary update information (e.g., Level 1 data) may be used to identifying erroneous or potentially erroneous quotes stored in the memory of the computer.

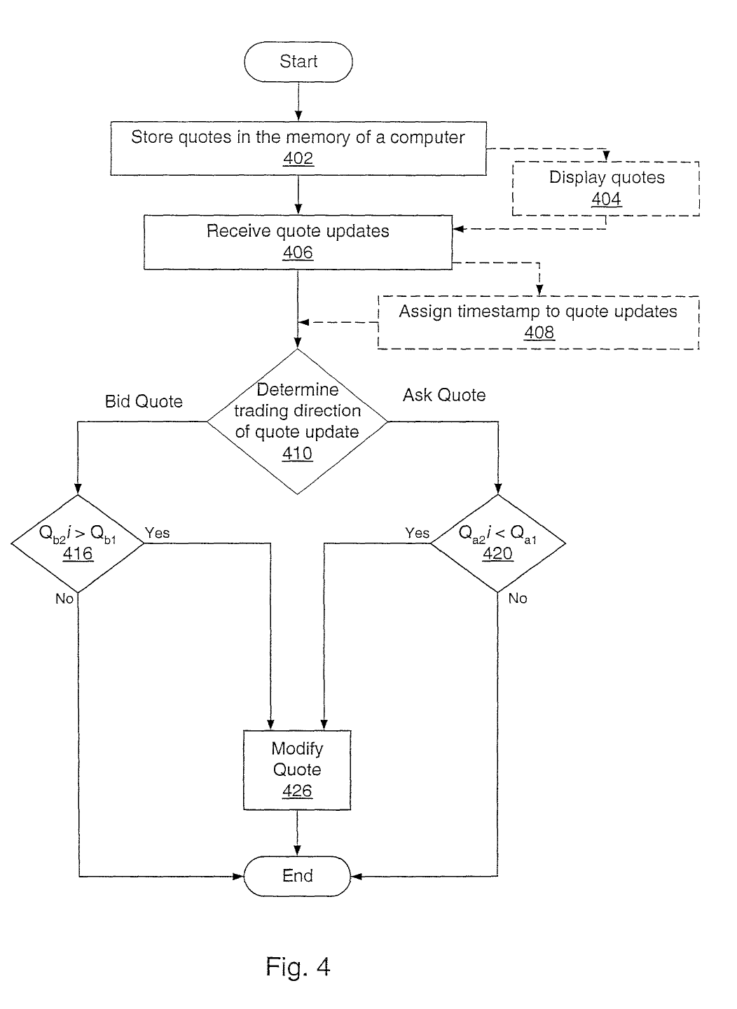

An embodiment of a method for identifying erroneous or potentially erroneous quote information is depicted in the flowchart of FIG. 4. The method may include storing quotes in the memory of a computer system (step 402). The quotes may be stored in the memory of the first computer system. Alternately, the quotes may be stored in the memory of the second computer system. The stored quotes may include a symbol (i.e., ticker symbol), a trading direction, a bid and/or ask price, and a market center identification. The stored quotes may also include a timestamp associated with each quote. The timestamp may indicate the time of receipt of the quote, or the time of origination of the quote. The market center identification may indicate which market center the quote comes from.

In some embodiments, the method may include displaying one or more quotes to a user (step 404, shown in dashed lines to indicate that the step may not be present in all embodiments). The quotes may be displayed periodically, continuously, or at the user's request. Displaying one or more quotes 404 may include displaying the quotes in a defined quote display format. The quote display format may include (but is not limited to) settings for the color, font size, font style, and display location. The quote display format may also include a setting for whether or not to include a quote in a particular display. For example, a quote display format for a given quote may include a setting indicating that the quote is not to be displayed to a user. This setting may be used to remove a quote from a user's display without removing the quote from a list of quotes in the memory of the computer.

The method may include receiving one or more quote updates (step 406). The received quote updates may include market summary update information from an automated securities market update system. Market summary update information may include market summary information as depicted in FIG. 3. In certain embodiments, a quote update may have a timestamp indicating the time of origination of the quote update. In certain embodiments, the method may include assigning a timestamp to the quote update (step 408, shown in dashed lines to indicate that the step may not be present in all embodiments). An assigned timestamp may indicate a time of receipt of the quote update.

The method may include determining the trading direction of a quote received (step 410). A bid quote (i.e., a solicitation to buy the security) may be compared to a bid quote criterion, generally referenced by numeral 416. An ask quote (i.e., a solicitation to sell the security) may be compared to an ask quote criterion, generally referenced by numeral 420.

The bid quote criterion (step 416) may be determining if the received quote update includes a bid price that is lower than the bid price of each quote stored in the memory of the computer. A received bid quote update may be represented by the variable Q_{b1}, while the one or more quotes stored in the memory of the computer may be represented by the variable Q_{b2}i, wherein “i” is a number indicating a particular quote in a series of quotes. In certain embodiments, the received quote update is a market summary quote update. A market summary quote update includes the best bid and best ask price available on the market at the time of the update. Therefore, if any quote price for the security stored in the memory of the computer Q_{b2}i is greater than a received bid quote update price Q_{b1}, either the quote update or the quote stored in the memory of the computer is erroneous. In such a case, bid quote criterion 416 is met. In certain embodiments, such as the embodiment depicted in FIG. 4, the method may include the assumption that received quote update Q_{b1} is correct. In such embodiments, the method may proceed to step 426 and modify the quote stored in the memory of the computer if bid quote criterion 416 is met.

The ask quote criterion (step 420) may be determining if the received quote update includes an ask price that is lower than the ask price of each quote stored in the memory of the computer. A received ask quote update may be represented by the variable Qₐ₁, while the one or more quotes stored in the memory of the computer may be represented by the variable Qₐ₂i, wherein “i” is a number indicating a particular quote in a series of quotes. In certain embodiments, the received quote update is a market summary quote update. A market summary quote update includes the best bid and best ask price available on the market at the time of the update. Therefore, if any quote price for the security stored in the memory of the computer Qₐ₂i is less than a received ask quote update price Qₐ₁, either the quote update or the quote stored in the memory of the computer is erroneous. In such a case, ask quote criterion 420 is met. In certain embodiments, such as the embodiment depicted in FIG. 4, the method may include the assumption that received quote update Qₐ₁ is correct. In such embodiments, the method may proceed to step 426 and modify the quote stored in the memory of the computer if ask quote criterion 420 is met.

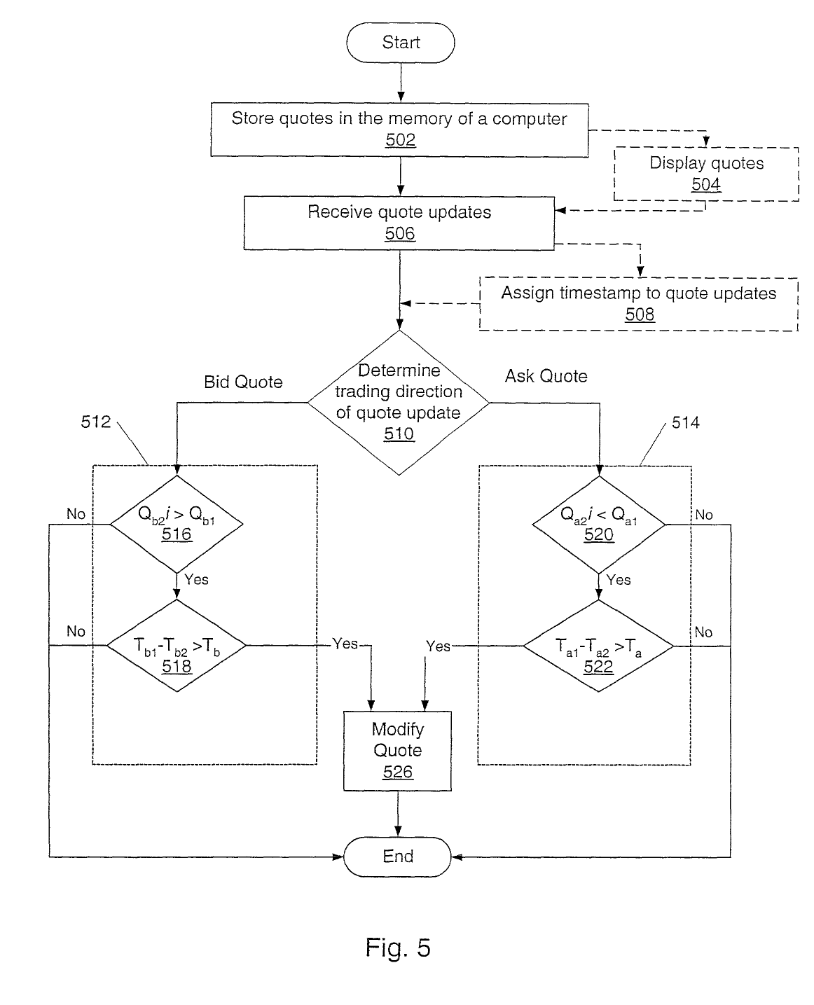

Another embodiment of a method for identifying erroneous or potentially erroneous quote information is depicted in the flowchart of FIG. 5. Like the embodiment depicted in FIG. 4, the method may include: storing quotes in the memory of a computer system (step 502); displaying one or more quotes to a user (step 504, shown in dashed lines to indicate that the step may not be present in all embodiments); receiving one or more quote updates (step 506); assigning a timestamp to the quote update (step 508, shown in dashed lines to indicate that the step may not be present in all embodiments); and determining the trading direction of a quote received (step 510).

However, in the embodiment depicted in FIG. 5, a bid quote may be compared to a plurality of bid quote criteria, generally referenced by numeral 512. Likewise, an ask quote may be compared to a plurality of ask quote criteria, generally referenced by numeral 514.

A first bid quote criterion (step 516) may be determining if the received quote update includes a bid price that is lower than the bid price of each quote stored in the memory of the computer. In certain embodiments, the received quote update is a market summary quote update. A market summary quote update includes the best bid and best ask price available on the market at the time of the update. Therefore, if any quote price for the security stored in the memory of the computer Q_{b2}i is greater than a received bid quote update price Q_{b1}, either the quote update or the quote stored in the memory of the computer is erroneous. In such a case, first bid quote criterion 516 is met.

In the embodiment depicted in FIG. 5, if first bid quote criterion 516 is met the method may proceed to the second bid quote criterion (step 518). Second bid quote criterion 518 may determine if the quote stored in the memory of the computer is older than the quote update by a predetermined threshold time. The predetermined threshold time may be a time value selected based on the time delays which are expected in a particular embodiment. For example, the selection of the predetermined threshold time may at least account for the normal time difference between processing market quote/order book information and market summary information. The selection of the predetermined threshold time may also account for other factors, including but not limited to: network transmission delays, processing delays, etc. In some embodiments, the predetermined time threshold value may be user configurable. To make the determination of step 518, a timestamp associated with the quote update (i.e., “T_{b1}”) may be compared to a timestamp associated with the quote stored in the memory of the computer (i.e., “T_{b2}”). If T_{b1} minus T_{b2} is greater than the predetermined threshold time (i.e. “T_{b}”), then second bid quote criterion 518 is met. If any of bid quote criteria 512 are not met, then the method may end. If all of bid quote criteria 512 are met, then the method may proceed to step 526 and modify the quote stored in the memory of the computer.

A first ask quote criterion (step 520) may be determining if the received quote update includes an ask price that is lower than the ask price of each quote stored in the memory of the computer. In certain embodiments, the received quote update is a market summary quote update. A market summary quote update includes the best bid and best ask price available on the market at the time of the update. Therefore, if any quote price for the security stored in the memory of the computer Qₐ₂i is less than a received ask quote update price Qₐ₁, either the quote update or the quote stored in the memory of the computer is erroneous. In such a case, first ask quote criterion 520 is met.

In other embodiments, the method may include a second ask quote criterion (step 522). Second ask quote criterion 522 may determine if the quote stored in the memory of the computer is older than the quote update by a predetermined threshold time. To make the determination of step 522, a timestamp associated with the quote update (i.e., “Tₐ₁”) may be compared to a timestamp associated with the quote stored in the memory of the computer (i.e., “Tₐ₂”). If Tₐ₁ minus Tₐ₂ is greater than the predetermined threshold time (i.e., “T_{b}”), then second ask quote criterion 522 is met. If any of ask quote criteria 514 are not met, then the method may end. If all of ask quote criteria 514 are met, then the method may proceed to step 526 and modify the quote stored in the memory of the computer.

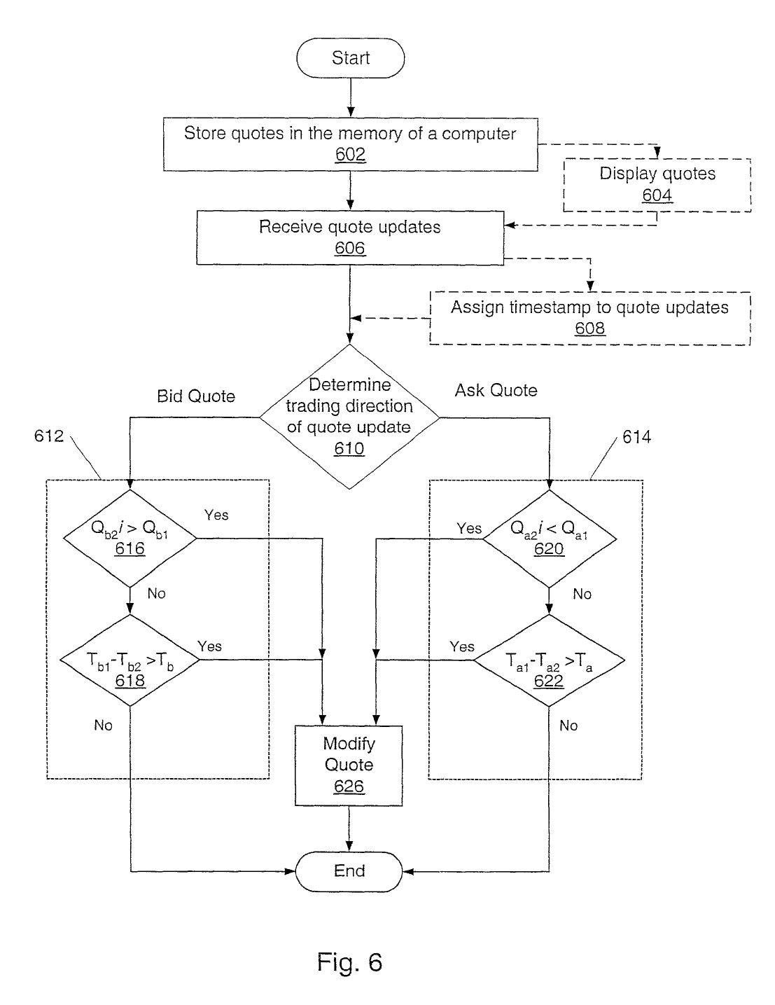

Another embodiment of a method for identifying erroneous or potentially erroneous quote information is depicted in the flowchart of FIG. 6. Like the embodiment depicted in FIGS. 4 and 5, the method may include: storing quotes in the memory of a computer system (step 602); displaying one or more quotes to a user (step 604, shown in dashed lines to indicate that the step may not be present in all embodiments); receiving one or more quote updates (step 606); assigning a timestamp to the quote update (step 608, shown in dashed lines to indicate that the step may not be present in all embodiments); and determining the trading direction of a quote received (step 610).

In the embodiment depicted in FIG. 6, a bid quote may be compared to a plurality of bid quote criteria, generally referenced by numeral 612. Likewise, an ask quote may be compared to a plurality of ask quote criteria, generally referenced by numeral 614.

A first bid quote criterion (step 616) may be determining if the received quote update includes a bid price that is lower than the bid price of each quote stored in the memory of the computer. In certain embodiments, the received quote update is a market summary quote update. A market summary quote update includes the best bid and best ask price available on the market at the time of the update. Therefore, if any quote price for the security stored in the memory of the computer Q_{b2}i is greater than a received bid quote update price Q_{b1}, either the quote update or the quote stored in the memory of the computer is erroneous. In such a case, first bid quote criterion 616 is met.

In the embodiment depicted in FIG. 6, if first bid quote criterion 616 is met the method may proceed to the second bid quote criterion (step 618). Second bid quote criterion 618 may determine if the quote stored in the memory of the computer is older than the quote update by a predetermined threshold time. The predetermined threshold time may be a time value selected based on the time delays which are expected in a particular embodiment. For example, the selection of the predetermined threshold time may at least account for the normal time difference between processing market quote/order book information and market summary information. The selection of the predetermined threshold time may also account for other factors, including but not limited to: network transmission delays, processing delays, etc. In some embodiments, the predetermined time threshold value may be user configurable. To make the determination of step 618, a timestamp associated with the quote update (i.e., “T_{b1}”) may be compared to a timestamp associated with the quote stored in the memory of the computer (i.e., “T_{b2}”). If T_{b1} minus T_{b2} is greater than the predetermined threshold time (i.e., “T_{b}”), then second bid quote criterion 618 is met. If all of bid quote criteria 612 are not met, then the method may end. If any of bid quote criteria 612 are met, then the method may proceed to step 626 and modify the quote stored in the memory of the computer.

A first ask quote criterion (step 620) may be determining if the received quote update includes an ask price that is lower than the ask price of each quote stored in the memory of the computer. In certain embodiments, the received quote update is a market summary quote update. A market summary quote update includes the best bid and best ask price available on the market at the time of the update. Therefore, if any quote price for the security stored in the memory of the computer Qₐ₂i is less than a received ask quote update price Qₐ₁, either the quote update or the quote stored in the memory of the computer is erroneous. In such a case, first ask quote criterion 620 is met.

In other embodiments, the method may include a second ask quote criterion (step 622). Second ask quote criterion 622 may determine if the quote stored in the memory of the computer is older than the quote update by a predetermined threshold time. To make the determination of step 622, a timestamp associated with the quote update (i.e., “Tₐ₁”) may be compared to a timestamp associated with the quote stored in the memory of the computer (i.e., “Tₐ₂”). If Tₐ₁ minus Tₐ₂ is greater than the predetermined threshold time (i.e., “T_{b}”), then second ask quote criterion 622 is met. If none of ask quote criteria 614 are met, then the method may end. If any of ask quote criteria 614 are met, then the method may proceed to step 626 and modify the quote stored in the memory of the computer.

Various embodiments further include receiving or storing instructions and/or data implemented in accordance with the foregoing description upon a carrier medium. Suitable carrier media may include storage media or memory media such as magnetic or optical media, e.g., disk or CD-ROM, as well as signals such as electrical, electromagnetic, or digital signals, conveyed via a communication medium such as networks 202 and/or 204 (as shown in FIG. 2) and/or a wireless link.

While the specific examples set forth herein generally relate to the NASDAQ Stock Market, it will be recognized by those skilled in the art that the embodiments may be applied to other securities markets as well.

It will be appreciated to those skilled in the art having the benefit of this disclosure that this invention is believed to provide methods and systems for displaying information related to securities to a user. Further modifications and alternative embodiments of various aspects of the invention will be apparent to those skilled in the art in view of this description. It is intended that the following claims be interpreted to embrace all such modifications and changes and, accordingly, the specification and drawings are to be regarded in an illustrative rather than a restrictive sense.

What is claimed is:

1. A computer-implemented method of providing a trader with one or more securities quotes comprising:
storing one or more quotes for a security in a memory of a computer, wherein each quote comprises a price and a trading direction;
receiving market summary update information comprising a quote update for the security, wherein the quote update comprises a price and a trading direction;
comparing the quote update and the quote stored in the memory of the computer via a first criterion; wherein the first criterion is met if:
for a bid quote, the price of the quote stored in the memory of the computer is greater than the price of the quote update, or
for an ask quote, the price of the quote stored in the memory of the computer is less than the price of the quote update; and
modifying the quote stored in the memory of the computer if the first criterion is met.

2. The method claim 1, wherein each quote stored in the memory of the computer, and each quote update further comprise a timestamp.

3. The method of claim 1, further comprising displaying to a user one or more of the quotes stored in the memory of the computer.

4. The method of claim 1, wherein a quote display format is associated with each quote stored in the memory of the computer, and wherein modifying the quote stored in the memory of the computer comprises modifying one or more quote display format settings associated with the quote.

5. The method of claim 4, wherein the quote display format comprises a font color setting, a font size setting, or a font style setting.

6. The method of claim 1, wherein modifying the quote stored in the memory of the computer comprises deleting the quote from the memory of the computer.

7. The method of claim 1, further comprising displaying the one or more quotes for a security stored in a memory of a computer remotely over a network.

8. The method of claim 1, wherein the network comprises the Internet.

9. A computer system configured to implement the method of claim 1.

10. A carrier medium which stores program instructions, wherein the program instructions are computer-executable to implement the method of claim 1.

11. A computer-implemented method of providing a trader with one or more securities quotes comprising:
storing one or more quotes for a security in a memory of a computer, wherein each quote comprises a timestamp;
receiving market summary update information comprising a quote update for the security, wherein the quote update comprises a timestamp;
comparing the quote update and the quote stored in the memory of the computer via a first criterion; wherein the first criterion is met if:
the timestamp of the quote update minus the timestamp of the quote stored in the memory of the computer greater than a predetermined threshold time; and
modifying the quote stored in the memory of the computer if the first criterion is met.

12. The method of claim 11, further comprising displaying to a user one or more of the quotes stored in the memory of the computer.

13. The method of claim 11, wherein a quote display format is associated with each quote stored in the memory of the computer, and wherein modifying the quote stored in the memory of the computer comprises modifying one or more quote display format settings associated with the quote.

14. The method of claim 13, wherein the quote display format setting comprises a font color setting, a font size setting, or a font style setting.

15. The method of claim 11, wherein modifying the quote stored in the memory of the computer comprises deleting the quote from the memory of the computer.

16. The method of claim 11, wherein the timestamp associated with the quote stored in the memory of the computer comprises a time of origination of the quote and the timestamp associated with the received quote update comprises a time of origination of the quote update.

17. The method of claim 11, wherein the timestamp associated with the quote stored in the memory of the computer comprises a time of receipt of the quote and the timestamp associated with the received quote update comprises a time of receipt of the quote update.

18. The method of claim 11, further comprising displaying the one or more quotes for a security stored in a memory of a computer remotely over a network.

19. The method of claim 11, wherein the network comprises the Internet.

20. The method of claim 11, wherein the predetermined time threshold is equal to zero.

21. The method of claim 11, further comprising receiving user configuration information from a user prior to comparing the quote update and the quote stored in the memory of the computer; wherein the user configuration information comprises a user selected value for the predetermined time threshold.

22. A computer system configured to implement the method of claim 11.

23. A carrier medium which stores program instructions, wherein the program instructions are computer-executable to implement the method of claim 11.

24. A computer-implemented method of providing a trader with one or more securities quotes comprising:
storing one or more quotes for a security in a memory of a computer, wherein each quote comprises a price, a timestamp, and a trading direction;
receiving market summary update information comprising a quote update for the security, wherein the quote update comprises a price, a timestamp, and a trading direction;
comparing the quote update and the quote stored in the memory of the computer via a first criterion; wherein the first criterion is met if:
for a bid quote, the price of the quote stored in the memory of the computer is greater than the price of the quote update, or
for an ask quote, the price of the quote stored in the memory of the computer is less than the price of the quote update;
comparing the quote update and the quote stored in the memory of the computer via a second criterion; wherein the second criterion is met if:
the timestamp of the quote update minus the timestamp of the quote stored in the memory of the computer greater than a predetermined threshold time; and
modifying the quote stored in the memory of the computer if the first criterion and second criterion are met.

25. The method of claim 24, further comprising displaying to a user one or more of the quotes stored in the memory of the computer.

26. The method of claim 24, wherein a quote display format is associated with each quote stored in the memory of the computer, and wherein modifying the quote stored in the memory of the computer comprises modifying one or more quote display format settings associated with the quote.

27. The method of claim 26, wherein the quote display format setting comprises a font color setting, a font size setting, or a font style setting.

28. The method of claim 24, wherein modifying the quote stored in the memory of the computer comprises deleting the quote from the memory of the computer.

29. The method claim 24, wherein the timestamp associated with the quote stored in the memory of the computer comprises a time of origination of the quote and the timestamp associated with the received quote update comprises a time of origination of the quote update.

30. The method of claim 24, wherein the timestamp associated with the quote stored in the memory of the computer comprises a time of receipt of the quote and the timestamp associated with the received quote update comprises a time of receipt of the quote update.

31. The method of claim 24, further comprising displaying the one or more quotes for a security stored in a memory of a computer remotely over a network.

32. The method of claim 24, wherein the network comprises the Internet.

33. The method of claim 24, wherein the predetermined time threshold is equal to zero.

34. The method of claim 24, further comprising receiving user configuration information from a user prior to comparing the quote update and the quote stored in the memory of the computer; wherein the user configuration information comprises a user selected value for the predetermined time threshold.

35. A computer system configured to implement the method of claim 24.

36. A carrier medium which stores program instructions, wherein the program instructions are computer-executable to implement the method of claim 24.
